(19) United States
(12) Patent Application Publication
(10) Pub. No.: US 2004/0157607 A1
(43) Pub. Date: Aug. 12, 2004

(54) Method and system for employing common data location register shared between public and private networks in high-speed wireless data system

(76) Inventors: Soo-Hwan Kim, Kyonggi-do (KR); Tai-Yoon Lee, Suwon-shi (KR)

Correspondence Address: Robert E. Bushnell, Suite 300, 1522 K Street, N.W., Washington, DC, 20005, US

(21) Appl. No.: 10/640,674

(22) Filed: Aug. 14, 2003

(30) Foreign Application Priority Data
Sep. 10, 2002 (KR) 2002-54629

(51) Int. Cl. H04Q 7/20

(52) U.S. Cl. 455/435.2; 455/433

(57) ABSTRACT

A method and system for employing a common data location register shared between public and private networks reduces an overload due to messages accompanied by an interface process when the public and private networks are interworked, and configure a cost-effective high-speed wireless data system. The high-speed wireless data system, includes an access network controller and a data location register. The controller is performing different authentication procedures according to a public network access node and a private network access node, assigning a UATI to each access node, managing a session of each access node, controlling transmission and reception data of each access node, requesting subscriber information to the common data location register and performing a transmission procedure based on received subscriber information, and transmitting a paging request to the common data location register and performing a reception procedure. The data location register including service information of the public network access node, information needed when the private network access node uses service of a wireless private network, and subscriber information of each access node, the data location register retrieving and is transmitting corresponding subscriber information, transmitting a paging response to a corresponding access network controller using source address information included in the paging request, and transmitting a paging response to a corresponding access network controller using paging information and paging area information.

### CLAIM OF PRIORITY

This application makes reference to, incorporates the same herein, and claims all benefits accruing under 35 U.S.C. §119 from an application for METHOD OF USING COMMON DATA LOCATION REGISTER OF PUBLIC NETWORK AND PRIVATE NETWORK PRIVATE IN WIRELESS HIGH SPEED DATA SYSTEM earlier filed in the Korean Industrial Property Office on Sep. 10, 2002 and there duly assigned Ser. No. 2002-54629.

### BACKGROUND OF THE INVENTION

1. Field of the Invention

The present invention relates to a high-speed wireless data system, and more particularly to a method and system for employing a common data location register shared between public and private networks.

2. Description of the Related Art

Conventionally, a mobile communication system has been developed to perform voice communications together with supporting mobility of a user. With the user's requirement, the mobile communication system based on the voice communications have been researched and developed so that it can further provide short data services. In other words, the mobile communication system basically provides voice communication services. Further, the mobile communication system provides short message transmission, music file transmission for use as a terminal bell sound, simple Internet communication services, fund transfer services, etc.

Developments of the mobile communication system which can provide the data services and rapidly provide much information to mobile communication subscribers are currently ongoing with a view to commercial applications. There is CDMA2000 1xEV-D0 (Code Division Multiple Access 2000 1×Evolution (Data Only)) (hereinafter, referred to as a high-speed wireless data system) as such a mobile communication system for high-speed data services. The high-speed wireless data system is considered as a system for rapidly transmitting data through a mobile communication terminal. Accordingly, the high-speed wireless data system has channels different from a pre-existing system. The channels necessary for rapidly transmitting the data include a data channel, a supplementary channel, a signaling channel, a MAC (Medium Access Control) channel, etc. A structure of each channel and a format of data to be transmitted through the channel have been researched. Characteristics of the high-speed wireless data system described above are different from those of a general wireless network.

The high-speed wireless data system described above is conventionally divided into a public network and a private network used for a specific purpose by companies and groups. The private network is configured so that it can be interworked with a specific public network. There is a method for providing the public network partially used as the private network. In such a method, the public network provides private network services to a mobile communication terminal when it is located in a specific area and provides public network services to the mobile communication terminal when it is located in other areas except for the specific area.

The public and private networks should be smoothly interworked so that the high-speed wireless data system can be appropriately driven. Accordingly, the interworking between components for the public and private networks should be smoothly performed. In particular, an interface between data location registers should be appropriately made.

Demand for the private network and a location in which it is installed should be necessarily considered before the private network is configured. Whenever a private network system is installed, public network configuration information should be updated. There is a problem in that a private data location register included in the high-speed wireless data system, which is different from a data location register, which is also included in the high-speed wireless data system, managed in a central office, should be locally managed. Because a data location register local manager managing a data location register requires high-priced devices in each network, it costs a great deal.

### SUMMARY OF THE INVENTION

It is therefore an object of the present invention to provide a method and system for employing a common data location register shared between public and private networks, which can reduce an overload due to messages accompanied by an interface process when the public and private networks are interworked.

It is another object of the present invention to provide a method and system for employing a common data location register shared between public and private networks, which can configure a cost-effective high-speed wireless data system.

In accordance with an aspect of the present invention, the above and other objects can be accomplished by the provision of a high-speed wireless data system for employing a common data location register shared between public and private networks, including: an access network controller for performing different authentication procedures according to a public network access node and a private network access node, assigning a UATI (Unicast Access Terminal Identifier) to each access node, managing a session of each access node, controlling transmission and reception data of each access node, requesting subscriber information to the common data location register and performing a transmission procedure based on received subscriber information if there is a call transmission request from the access node through an access network transceiver system, and transmitting a paging request to the common data location register and performing a reception procedure if there is a call reception request from a communication node; and a data location register including service information of the public network access node, information needed when the private network access node uses service of a wireless private network, and subscriber information of each access node, the data location register retrieving and transmitting corresponding subscriber information if there is a subscriber information request from the access network controller, transmitting a paging response to a corresponding access network controller using source address information included in the paging request if there is a paging request from the access network controller belonging to the private network, and transmitting a paging response to a corresponding access network controller using paging information and paging area information if there is a paging request from the access network controller belonging to the public network.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view illustrating a configuration of a conventional high-speed wireless data system;

FIG. 2 is a view illustrating a configuration of a high-speed wireless data system in accordance with an embodiment of the present invention;

FIG. 3 is a flow chart illustrating a flow of messages in a signal transmission procedure in accordance with an embodiment of the present invention;

FIG. 4 is a flow chart illustrating a flow of messages in a signal reception procedure in accordance with an embodiment of the present invention; and

FIG. 5 is a flow chart illustrating an operation of a data location register when an incoming call is received in accordance with an embodiment of the present invention.

### DETAILED DESCRIPTION OF THE PREFERRED EMBODIMENTS

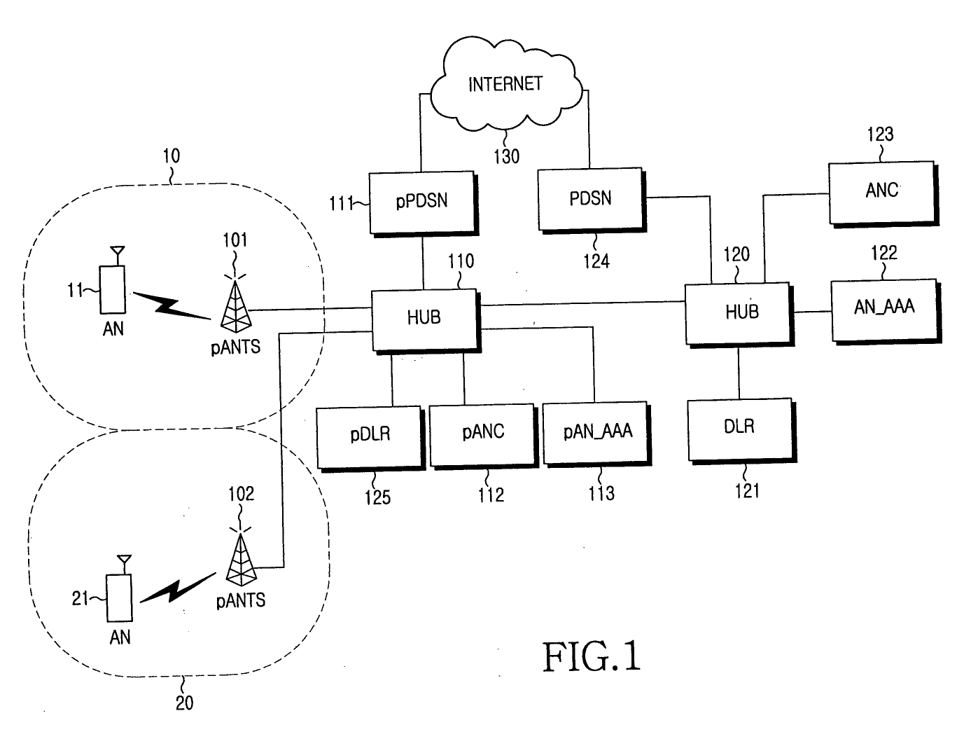

FIG. 1 is a view illustrating a configuration of a conventional high-speed wireless data system and also a configuration of a network capable of employing both public and private networks. In FIG. 1, a small letter “p” is attached to names of nodes used for only the private network or nodes used for both public and private networks so that private network nodes can be distinguished.

As shown in FIG. 1, the high-speed wireless data system includes ANs (Access Nodes) 11 and 21, pANTSs (private Access Network Transceiver Systems) 101 and 102, hubs 110 and 120, a pANC (private Access Network Controller) 112, an ANC (Access Network Controller) 123, a pPDSN (private Packet Data Serving Node) 111, a PDSN (Packet Data Serving Node) 124, a pAN_AAA (private Access Network Authentication Accounting Authorization) 113, an AN_AAA (Access Network Authentication Accounting Authorization) 122, a pDLR (private Data Location Register) 125 and a DLR (Data Location Register) 121.

The public and private networks should be smoothly interworked so that the high-speed wireless data system can be appropriately driven. Accordingly, the interworking between components for the public and private networks should be smoothly performed. In particular, an interface between data location registers should be appropriately made. The data location registers manage session information, authentication information, location information, etc. associated with the ANs, or system configuration information, and support the mobility of the ANs.

As shown in FIG. 1, where the high-speed wireless data system includes the private network, the high-speed wireless data system receives and transmits the session information, the location information, etc. associated with the ANs through A13 interfaces of the pDLR 125 for the private network and the DLR 121 for the public network. If the private network is installed in a relatively narrower area where a mobile communication load is heavy, or in a dense telecommunication area, a load of a system increases and therefore a public network system adjacent to the system also increases because of the increased number of transmissions of A13 interface messages. Demand for the private network and a location in which it is installed should be necessarily considered before the private network is configured. Whenever a private network system is installed, public network configuration information should be updated. There is a problem in that the pDLR 125, which is different from the DLR 121 managed in a central office, should be locally managed. Because a DLM (DLR Local Manager) managing a data location register requires high-priced devices in each network, it costs a great deal.

Now, preferred embodiments of the present invention will be described in detail with reference to the annexed drawings. In the following description, a detailed description of known functions and configurations incorporated herein will be omitted when it may make the subject matter of the present invention rather unclear.

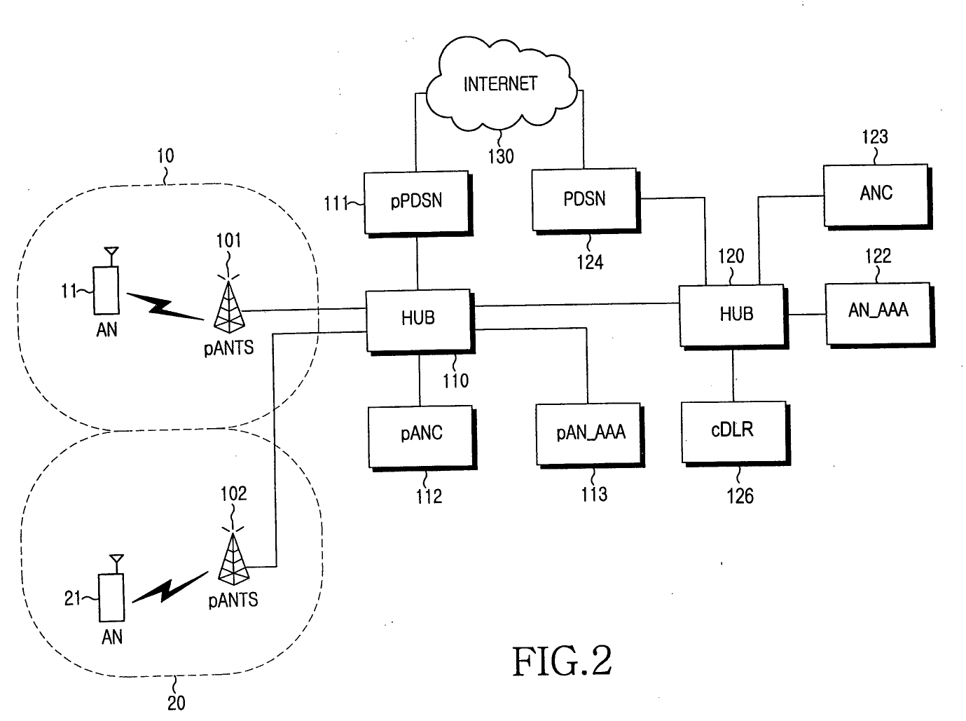

First, a configuration of a high-speed wireless data system in which the present invention is applied will be described with reference to FIG. 2. FIG. 2 is a view illustrating a configuration of a high-speed wireless data system in accordance with the present invention. In FIG. 2, a small letter “p” is attached to names of nodes used for only the private network or nodes used for both public and private networks so that private network nodes can be distinguished. As shown in FIG. 2, the high-speed wireless data system includes ANs (Access Nodes) 11 and 21, pANTSs (private Access Network Transceiver Systems) 101 and 102, hubs 110 and 120, a pANC (private Access Network Controller) 112, an ANC (Access Network Controller) 123, a pPDSN (private Packet Data Serving Node) 111, a PDSN (Packet Data Serving Node) 124, a pAN_AAA (private Access Network Authentication Accounting Authorization) 113, an AN_AAA (Access Network Authentication Accounting Authorization) 122, and a cDLR (common Data Location Register) 126.

The ANs 11 and 21 are ANs for use in a general high-speed wireless data system. It is assumed that the AN 11 is a subscriber simultaneously employing a wireless private network service and a wireless public network service and the AN 21 is another subscriber employing the wireless public network. Each of the pANTSs 101 and 102 shown in FIG. 2 has predetermined radio areas 10 and 20, establishes a session where the AN moves to the radio area, and performs a necessary operation when a UATI (Unicast Access Terminal Identifier) is assigned to the AN. Further, each of the pANTSs 101 and 102 performs a corresponding operation when there is an incoming call to the AN, or an outgoing call from the AN. The pANTSs 101 and 102 are coupled to the hub 110.

The hub 110 is coupled to another hub so that respective nodes within the private network and other nodes of the public network or other nodes are coupled. As shown in FIG. 2, the hub 110 is coupled to another hub 120 being coupled to outside of the private network. Further, the hub 110 is coupled to the pPDSN 111, which can be only used by ANs of the private network. Further, the hub 110 is coupled to the pANC 112 and the pAN_AAA 113, thereby performing a data relay. Here, the pAN_AAA 113 can be configured so that it is shared between a wireless private network and a wireless public network.

The pANC 112 and the ANC 123 control the session establishment for the AN, the UATI assignment and the AN authentication through the pAN_AAA 113. Further, the pANC 112 performs a service routing directed to the ANs of the private network or the pPDSN 111 and the outside of the private network. Furthermore, the pANC 112 performs the session establishment and update for the AN authentication, control for the UATI assignment, a traffic control according to a call set-up, various signalling control, etc. For example, the pANC 112 transmits a paging signal to the AN, assigns session information to the cDLR 126 or updates the session information, stores location information in the cDLR 126, and assigns the UATI.

Another hub 120 is coupled to the AN_AAA 122, the ANC 123, the PDSN 124 and the cDLR 126 storing the AN information, and performs a data relay between respective nodes. Further, the hub 120 can be coupled to an access network transceiver system of the wireless public network not shown in FIG. 2.

The PDSN 124 is coupled to another PDSN or the pPDSN 111 through an Internet 300. Further, the ANC 123 of the public network is a general ANC of the high-speed wireless data system, and the AN_AAA 122 is a general AN_AAA of the high-speed wireless data system.

The cDLR 126 stores the AN information and the AN location information associated with the high-speed wireless data system, and provides the AN information when the session of the AN is updated. Further, the cDLR 126 stores information of ANs included in a general wireless public network. The AN information of the general wireless public network includes AN state information, user information, a grade of service, etc. Furthermore, the cDLR 126 further includes AN information of the wireless private network. At this time, the information contained in the cDLR 126 can be classified into a case where the ANs can use service provided by only the private network and another case where the ANs can use services provided by both public and private networks. However, in accordance with the present invention, the information contained in the cDLR 126 corresponds to the case where the ANs can use services provided by both public and private networks. In this case, the cDLR 126 includes public network AN information and private network AN information. The private network AN information includes information of a service area, e.g., a service ANC or a sector, information of a service use time and a type of service. Where the cDLR 126 assigns the UATI to the AN, the cDLR 126 can be configured so that it can assign the UATI on the basis of a particular standard.

Further, where the AN of the wireless private network uses service, the cDLR 126 can further transmit an identifier necessary for identifying a connection to the wireless private network or a connection to the public network.

The pANTSs 101 and 102, the cDLR 126, the pANC 112, the ANC 123, the pPDSN 111 and the PDSN 124 can be configured on the basis of an IP (Internet Protocol). Generally, a connection between ANTSs and an ANC, and a connection between a DLR and PDSNs are configured on the basis of an ATM (Asynchronous Transfer Mode). This connection requires significant costs. Accordingly, the configuration based on the IP can effectively reduce costs. Where the pANTSs 101 and 102, the cDLR 126, the pANC 112, the ANC 123, the pPDSN 111 and the PDSN 124 can be configured on the basis of the IP, communications between respective boards or processors within respective nodes is based on IPC (Inter-Processor (or Process) Communication). Internal IP addresses are assigned to respective boards or processors within respective nodes. Where the nodes are located within a central office or a control station, the internal IP addresses are assigned to the nodes. Fixed IP addresses are assigned to the nodes located at a long distance from the central office or the control station. Accordingly, an insufficiency of the number of IP addresses can be prevented.

An interface between the pANTSs 101 and 102, the pANC 112 and the ANC 123 can be made through an ADSL modem or a cable modem. Because the pAN_AAA 113, the AN_AAA 122, the pPDSN 111 and the PDSN 124 are initially implemented on the basis of the IP, there is no problem.

An outgoing call transmission procedure of an AN coupled to the private network and an incoming call reception procedure of the AN coupled to the private network in the high-speed wireless data system will be described with reference to FIGS. 2 to 5.

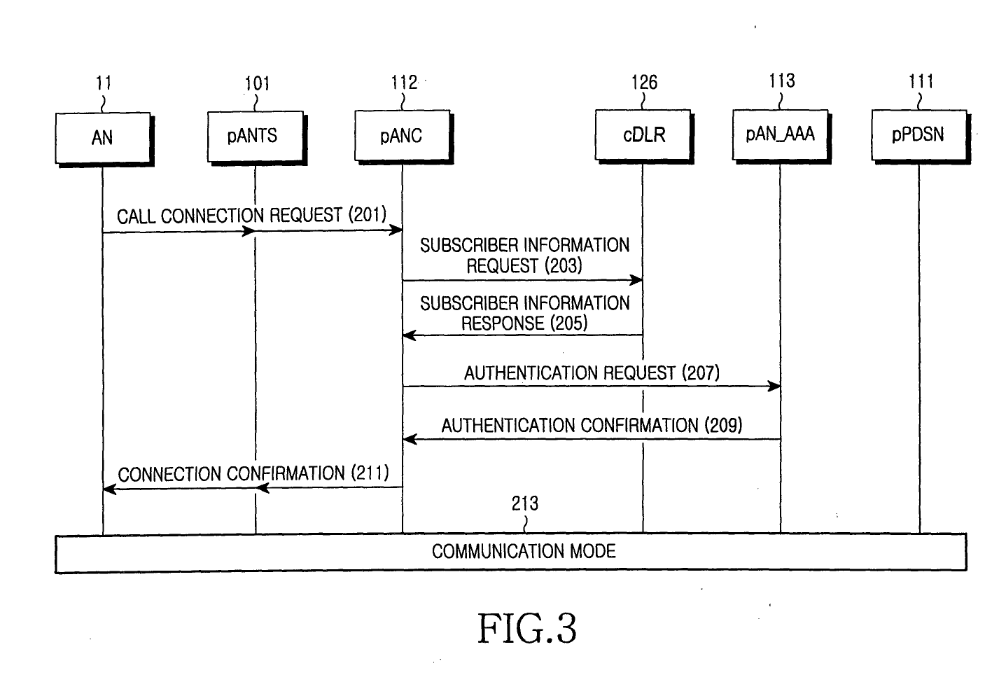

First, a procedure of transmitting an outgoing call from the AN 11, coupled to the private network, to the pPDSN 111 will be described with reference to FIGS. 2 and 3. FIG. 3 is a flow chart illustrating a flow of messages in a signal transmission procedure in accordance with an embodiment of the present invention.

Where the AN 11 of the wireless private network requests a 1xEV-D0 service at step 201, AN 11 transmits a connection request message including a UATI and a destination address to the pANTS 101 on the basis of a defined air interface standard. If the pANTS 101 receives the connection request message, pANTS 101 performs an IP communication process and then transmit the connection request message to the hub 110. The hub 110 transmits the connection request message to the pANC 112. If the pANC 112 receives the connection request message, pANC 112 transmits a subscriber information request message for a destination terminal to the cDLR 126 through the hubs 110 and 120 at step 203. If the cDLR 126 receives the subscriber information request message, cDLR 126 retrieves corresponding subscriber information and transmits a subscriber information response message including the subscriber information to the pANC 112 at step 205. If the pANC 112 receives the subscriber information from the cDLR 126, pANC 112 transmits an authentication request message to the pAN_AAA 113 at step 207. In response to the authentication request message, the pAN_AAA 113 performs the authentication based on the UATI of the AN 11 and then transmits an authentication confirmation message to the pANC 112 at step 209. If the pANC 112 receives the authentication confirmation message, pANC 112 transmits a connection confirmation signal to the AN 11 through an air interface at step 211. The AN 11 receiving the connection confirmation signal communicates with the target pPDSN 111 in a communication mode 213. Since it is assumed that a call connection request is directed to the wireless private network in the above description, a case where the AN 11 communicates with the pPDSN 111 has been described. Another case where the AN 11 communicates with the PDSN 124 is similar to the prior case, except that the hub 120 and the AN_AAA 122 are additionally used.

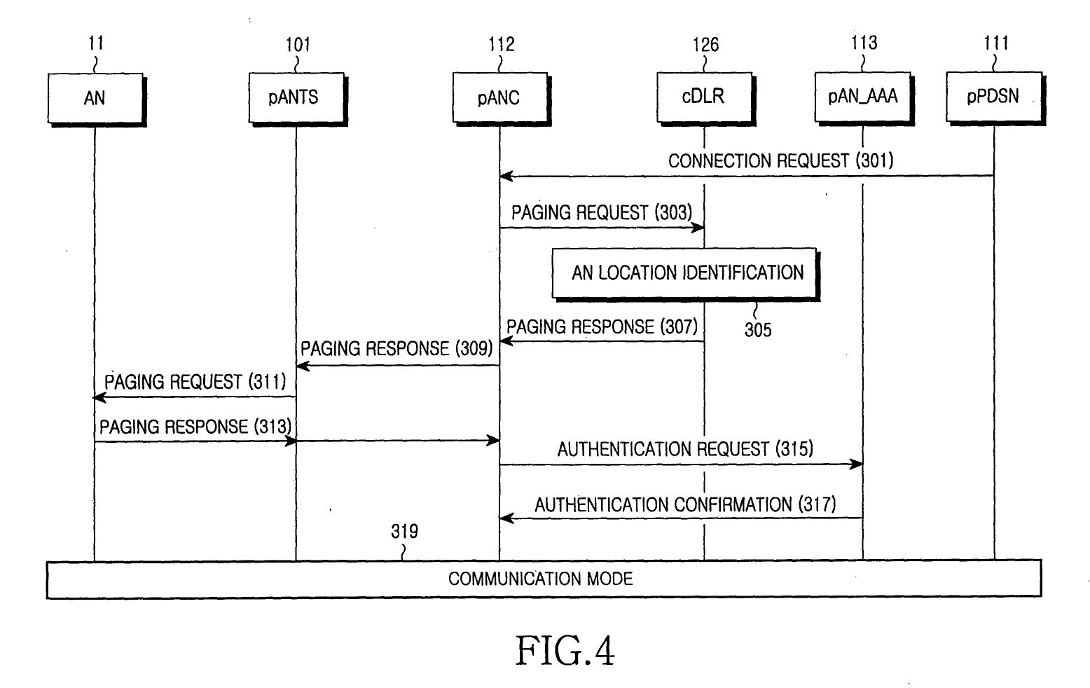

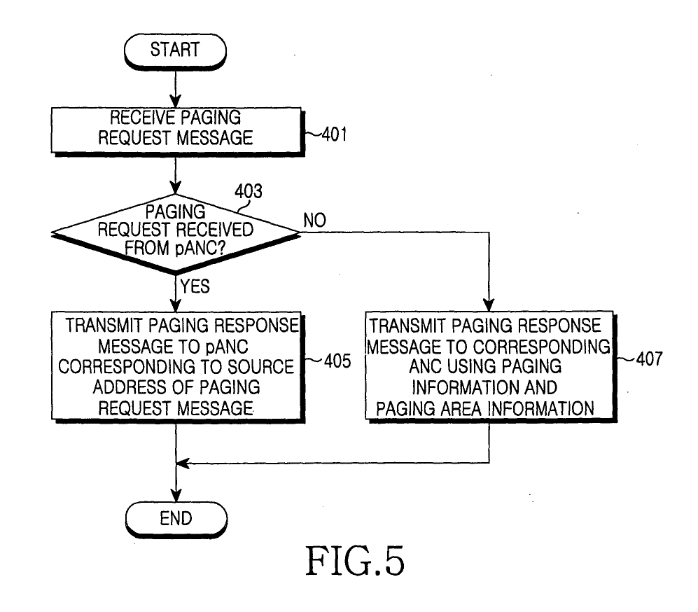

Next, a procedure of directing an incoming signal to the private network of the high-speed wireless data system in accordance with the present invention will be described with reference to FIGS. 4 and 5. FIG. 4 is a flow chart illustrating a flow of messages in a signal reception procedure in accordance with an embodiment of the present invention, and FIG. 5 is a flow chart illustrating an operation of a data location register when an incoming call is received in accordance with an embodiment of the present invention.

Referring to FIG. 4, where an incoming call reception request is transmitted from the pPDSN 111 to the AN 11 of the wireless private network, the pPDSN 111 transmits a connection request message to the pANC 112 at step 301. The pANC 112 is an ANC performing only an operation associated with the wireless private network or an ANC performing an operation associated with the wireless public and private networks. At this time, the connection request message is transmitted through the hub 110. The transmission of the connection request message through the hub is not shown in FIG. 4.

In response to the connection request message, the pANC 112 transmits a paging request message to the cDLR 126 at step 303. If the cDLR 126 receives the paging request message, cDLR 126 identifies corresponding subscriber information, that is, a location of the AN 11 at step 305. The cDLR 126 determines whether the paging request message has been received from the pANC 112 or the ANC 123 coupled to the public network, and then transmits subscriber information response information to a corresponding ANC. In other words, the cDLR 126 refers to a source address of the paging request message or system configuration information of a corresponding AN, and transmits a paging response message to the corresponding ANC. An operation procedure of the cDLR 126 is shown in FIG. 5. A detailed description will be given of a procedure of retrieving subscriber information for a paging request in the cDLR 126 in connection with FIG. 5. If the cDLR 126 receives the paging request message from the pANC 112 at step 401, it proceeds to step 403. The paging request message includes a source ANC identification field. The source ANC identification field is used for identifying a source ANC of the paging request message. The cDLR 126 checks the source ANC identification field, and then determines at the above step 403 whether the paging request has been received from the pANC 112 or the ANC 123 coupled to the public network. If the paging request has been received from the pANC 112, the cDLR 126 proceeds to step 405. On the other hand, if the paging request has been received from the ANC 123 coupled to the public network, the cDLR 126 proceeds to step 407. At the above step 405, the cDLR 126 transmits the paging response message to the pANC 112 corresponding to the source address of the paging request message. At the above step 407, the cDLR 126 transmits the paging response message to a corresponding ANC belonging to a paging area using paging information and paging area information included in system configuration information.

Returning to FIG. 4, the pANC 112 receiving the paging response message from the cDLR 126 at step 307 transmits a paging request message to the pANTS 101 at step 309. The pANTS 101 transmits the paging request message to the AN 11 at step 311. In response to the paging request message, the AN 11 transmits the paging response message at step 313. The paging response message is transmitted to the pANC 112 through the pANTS 101. If the pANC 112 receives the paging response message, pANC 112 transmits an authentication request message to the pAN_AAA 113 at step 315. If the pAN_AAA 113 receives the authentication request message, pAN_AAA 113 performs an authentication procedure and then transmits an authentication confirmation message to the pANC 112 at step 317. If the pANC 112 receives the authentication confirmation message, the pPDSN 111 communicates with the target AN 11 in a packet communication mode 319.

As apparent from the above description, the present invention provides a method and system for employing a common data location register shared between public and private networks, which can reduce an overload due to messages accompanied by an interface process when the public and private networks are interworked, and configure a cost-effective high-speed wireless data system.

Although the preferred embodiments of the present invention have been disclosed for illustrative purposes, those skilled in the art will appreciate that various modifications, additions and substitutions are possible, without departing from the scope of the invention. Therefore, the present invention is not limited to the above-described embodiments, but the present invention is defined by the claims which follow, along with their full scope of equivalents.

What is claimed is:

1. A wireless data system, comprising:
an access network controller performing different authentication procedures according to a public network access node and a private network access node, managing a session of each access node, and controlling transmission and reception data of each access node; and
a data location register being shared between public and private networks and including service information of the public network access node, information needed when the private network access node uses service of a wireless private network, and subscriber information of each access node, the data location register retrieving and transmitting corresponding subscriber information when there is a subscriber information request from the access network controller.

2. The wireless data system of claim 1, with the data location register transmitting a paging response to a corresponding access network controller using source address information included in the paging request when there is a paging request from the access network controller belonging to the private network.

3. The wireless data system of claim 1, with the data location register transmitting a paging response to a corresponding access network controller using paging information and paging area information when there is a paging request from the access network controller belonging to the public network.

4. The wireless data system of claim 1, with the access network controller assigning a Unicast Access Terminal Identifier to each access node.

5. The wireless data system of claim 1, with the access network controller requesting subscriber information to the common data location register and performing a transmission procedure based on received subscriber information when there is a call transmission request from the access node through an access network transceiver system.

6. The wireless data system of claim 1, with the access network controller transmitting a paging request to the common data location register and performing a reception procedure when there is a call reception request from a communication node.

7. The wireless data system of claim 1, with the access network controller and data location register being configured on the basis of Internet protocol.

8. The wireless data system of claim 1, with the access network controller transmitting an access network controller identification information to the data location register when transmitting the paging request, the access network controller identification information indicating whether the access network controller belongs to the private network or the public network.

9. The wireless data system of claim 1, with the data location register transmitting a paging response to a corresponding access network controller using source address information included in the paging request when there is a paging request from the access network controller belonging to the private network, the data location register transmitting a paging response to a corresponding access network controller using paging information and paging area information when there is a paging request from the access network controller belonging to the public network.

10. The wireless data system of claim 1, with the access network controller assigning a Unicast Access Terminal Identifier to each access node, the access network controller requesting subscriber information to the common data location register and performing a transmission procedure based on received subscriber information when there is a call transmission request from the access node through an access network transceiver system, the access network controller transmitting a paging request to the common data location register and performing a reception procedure when there is a call reception request from a communication node, the access network controller and data location register being configured on the basis of Internet protocol, the access network controller transmitting an access network controller identification information to the data location register when transmitting the paging request, the access network controller identification information indicating whether the access network controller belongs to the private network or the public network.

11. The wireless data system of claim 1, with the data location register transmitting a paging response to a corresponding access network controller using source address information included in the paging request when there is a paging request from the access network controller belonging to the private network, the data location register transmitting a paging response to a corresponding access network controller using paging information and paging area information when there is a paging request from the access network controller belonging to the public network.

12. The wireless data system of claim 11, with the access network controller requesting subscriber information to the common data location register and performing a transmission procedure based on received subscriber information when there is a call transmission request from the access node through an access network transceiver system.

13. A high-speed wireless data system for employing a data location register shared between public and private networks, comprising:
an access network controller, requesting subscriber information of an access node to the data location register and performing a transmission procedure based on received subscriber information through an authentication procedure when there is a call transmission request, and transmitting a paging request to the data location register and performing a reception procedure when there is a call reception request; and
the data location register being shared between public and private networks including service information of the public network access node, information needed when the private network access node uses service of a wireless private network, and subscriber information of each access node, the data location register storing subscriber information and location information for an access node of the wireless high-speed data system, retrieving and transmitting corresponding subscriber information when there is a subscriber information request from the access network controller, transmitting a paging response to a corresponding access network controller using source address information included in the paging request when there is a paging request from the access network controller belonging to the private network, and transmitting a paging response to a corresponding access network controller using paging information and paging area information when there is a paging request from the access network controller belonging to the public network.

14. The high-speed wireless data system as set forth in claim 13, with the access network controller transmitting an access network controller identification information to the data location register when transmitting the paging request, the access network controller identification information indicating whether the access network controller belongs to the private network or the public network.

15. A call transmission method for employing a common data location register shared between public and private networks in a high-speed wireless data system, comprising the steps of:
allowing an access network controller belonging to the private network to request subscriber information in response to a call connection request from an access node;
allowing the data location register to retrieve corresponding subscriber information in response to the subscriber information request and transmit the subscriber information to the access network controller; and
allowing the access network controller to transmit an authentication request to a private Access Network Authentication Accounting Authorization when the access network controller receives the subscriber information transmitted from the data location register, checking a connection of an access node when there is a authentication confirmation from the private Access Network Authentication Accounting Authorization based on the received subscriber information, and performing a communication.

16. A call reception method for employing a common data location register shared between public and private networks in a high-speed wireless data system, comprising the steps of:
transmitting a paging request message to the data location register when a access network controller receives an incoming call reception request;
receiving the paging request message in the data location register;
when the paging request message is received in the data location register, checking whether the paging request message is transmitted from an access network controller belonging to the private network or whether the paging request message is transmitted from an access network controller belonging to the public network;
allowing the data location register to transmit a paging response to a corresponding access network controller using source address information included in the paging request message when there is a paging request message from an access network controller belonging to the private network;
allowing the data location register to transmit a paging response to a corresponding access network controller using paging information and paging area information when there is a paging request message from an access network controller belonging to the public network; and
allowing the access network controller receiving the paging response to perform a reception procedure.

17. The call transmission method as set forth in claim 15, further comprising the steps of:
allowing the access network controller to transmit an authentication request to a private Access Network Authentication Accounting Authorization when the access network controller receives the subscriber information;
allowing the private Access Network Authentication Accounting Authorization to perform the authentication confirmation for the subscriber information; and
checking a connection of an access node when there is an authentication confirmation from the private Access Network Authentication Accounting Authorization, and performing a communication.

18. The call reception method as set forth in claim 16, further comprising the steps of:
allowing the access network controller receiving the paging response to transmit a paging request to a corresponding access node;
transmitting an authentication request to a private Access Network Authentication Accounting Authorization when there is a paging request from the access node; and
performing data communication when there is the authentication confirmation from a private Access Network Authentication Accounting Authorization.

19. A method, comprising:
receiving a paging request message from a first access network controller by a data location register shared between public and private networks, the first access network controller being connected to at least one private network;
checking the source access network controller identification field and determining whether the paging request has been received from one of the first access network controller and a second access network controller by the data location register, the second access network controller being connected to only public networks;
transmitting the paging response message to the first access network controller corresponding to the source address of the paging request message by the data location register when the data location register receives the paging request from the first access network controller; and
transmitting the paging response message to a corresponding access network controller belonging to a paging area using paging information and paging area information included in system configuration information by the data location register.

20. The method of claim 19, with the paging request message including a source access network controller identification field used to identify a source access network controller of the paging request message.
